(19) United States
(12) Patent Application Publication
(10) Pub. No.: US 2006/0252385 A1
(43) Pub. Date: Nov. 9, 2006

(54) Hand-held input device having rotating mechanism

(75) Inventors: Chien-Lung Huang, Tantz Shiang (TW); Hsin-Pin Yu, Tantz Shiang (TW)

Correspondence Address: MADSON & AUSTIN;GATEWAY TOWER WEST, SUITE 900, 15 WEST SOUTH TEMPLE, SALT LAKE CITY, UT, 84101, US

(73) Assignee: Asia Optical Co., Inc.

(21) Appl. No.: 11/418,979

(22) Filed: May 5, 2006

(30) Foreign Application Priority Data
May 6, 2005 (TW) 094114753

(51) Int. Cl. H04B 1/38; H04M 1/00

(52) U.S. Cl. 455/90.3; 455/575.3

(57) ABSTRACT

Disclosed is a hand-held input device having a rotating mechanism. The hand-held input device includes a shell body and a rotating component. An outer surface of the shell body forms a storage cavity in which a spindle hole and a guide groove are formed. The rotating component is assembled with a spindle and a guider that the spindle and the guider match with the spindle hole and the guide groove of the shell body respectively. The spindle is fixed a pressing ring with an elastic part therebetween. A cover is capped on the storage. The elastic part keeps a space between the shell body and the rotating component. A rotation limitation mechanism limits the rotation of the rotating component within a specified rotating angle range with respect to the shell body by the limitation of the guide groove to the guider.

### FIELD OF THE INVENTION

The present invention generally relates to a hand-held input device having a rotating mechanism, and more particularly, to a hand-held input device having a rotating mechanism which can be applied to a cellular phone, Personal Digital Assistant, a hand-held satellite navigation system or et cetera.

### BACKGROUND OF THE INVENTION

Presently, hand-held input devices, such as mobile phones, Personal Digital Assistants (PDAs), and hand-held satellite navigation system are provided with a display component and an input component. The display component can be STN or TFT monitor and the input component can be an input device, such as a keyboard and a touch panel. Basically, the hand-held input devices can be categorized as one-body type and folding type, that comprise separate display component and input component that are mounted together with for example a rotating pivot.

Besides, a display that can vertically rotate 360-degree is disclosed in TW Patent No. 244667 and a hand-held input device having a lift cover is disclosed in U.S. Pat. No. 6,088,240. However, additional services of mobile phone, such as Java Game, newsletter novel are in vogue now and exhibiting the word, with frame content of such additional service being set in vertical lines in the display. Most displays of the hand-held input devices available in the present day are fixed to exhibit content in horizontal lines in the display for being light and handy. When the additional service is desired, a user has to put the hand-held input device horizontally in order to increase the exhibiting content horizontally and this causes great inconvenient to the user.

Moreover, a hand-held input device with rotating mechanism is disclosed in TW Patent No. 572507, wherein a display 22 is embedded in a rotating dish 2. The rotating dish 2 is assembled to a fixing platform 3, and with a limitation element and a first stopper 12 and a second stopper 13, the rotating angle of the rotating dish 2 is restricted on the fixing platform 3 so that the rotating angle of the display 22 is also restricted.

However, such mechanism is assembled with the fixing platform and the rotating dish. Both of the fixing platform and the rotating dish has their own thicknesses, which cause the difficulty of the miniaturization for the hand-held input device. Moreover, due to the circular hole on the shell body of the hand-held input device for assembling the dish, the size of the display will be restricted by the shell body. A bigger display cannot be adopted.

Furthermore, with the more development and more popularization of transmitting SMS (Short Message Service) through the hand-held input device, inputting messages conveniently and quickly becomes a thirsty requirement to users. Therefore, there is a need of a mechanism design applied for the display component (monitor) and the input component (keyboard) of the hand-held input device to rotate the display component and the input component in a specified rotating angle for convenient operation for user. Consequently, a great following benefit is dedicated to the hand-held input device user widely.

### SUMMARY OF THE INVENTION

To solve the foregoing drawbacks in the prior art, it is an objective of the present invention to provide a hand-held input device having a rotating mechanism, which has a simple structure, sufficing the requirement of miniaturization and thinning-down to the hand-held input device. The rotating mechanism provides enough space for bigger size display component or input component and is convenient to be rotated a specified angle for exhibiting content or inputting according to user's demand.

To accomplish the above objects, the present invention provides a hand-held input device having a rotating mechanism. The hand-held input device comprises a shell body, a rotating component and a rotation limitation mechanism, wherein a spindle hole is formed in the shell body. The rotating component is provided with a spindle matching with the spindle hole of the shell body to make the rotating component rotatably mounted to the shell body. The rotation limitation mechanism, assembled at one of the shell body and the rotating component or both, limits the rotation of the rotating component within a specified rotating angle range with respect to the shell body.

The hand-held input device having a rotating mechanism is provided for the objectives of the present invention, wherein the rotation limitation mechanism comprises a guide groove and a guider movably received in the guide groove, and wherein the guide groove and the guider are assembled at the shell body and the rotating component respectively.

The hand-held input device having a rotating mechanism is provided for the objectives of the present invention, wherein the shell body comprises a display component and an input component revolvable jointed together by a spindle or a display component and an input component united in one piece.

The hand-held input device having a rotating mechanism is provided for the objectives of the present invention, wherein an outer surface of the shell body forms a storage cavity in which the spindle hole and the guide groove are formed.

The hand-held input device having a rotating mechanism is provided for the objectives of the present invention, wherein the spindle is screwed to a pressing ring with an elastic part therebetween to keep a space between the shell body and the rotating component.

The hand-held input device having a rotating mechanism is provided for the objectives of the present invention, wherein the hand-held input device further comprises a cover capping the storage. The spindle, spindle hole, elastic part, pressing ring and the cover are assembled along same axis.

The hand-held input device having a rotating mechanism is provided for the objectives of the present invention, wherein the spindle of the rotating component is further attached with a torsional spring having one end fixed to the shell body and an opposite end fixed to the rotating component to drive the rotating component rotating automatically if no resistance is applied on the rotating component.

The hand-held input device having a rotating mechanism is provided for the objectives of the present invention, wherein the shell body further comprises a button hole, in which a detent button is received, and a mortise set up on the rotating component corresponding to the detent button to locate the rotating component by engaging the detent button with the mortise.

To compare with prior arts, the hand-held input device having a rotating mechanism according to the present invention can assemble the display component or the input component on the rotating component. The rotating component is operated with the shell body by the spindle through the spindle hole. With the rotation limitation mechanism, the rotating component can be limited within the specified rotating angle range with respect to the shell body to provide a proper display position or a proper input position by rotating the display component or the input component to an appropriate position according to user's demand. The hand-held input device having a rotating mechanism according to the present invention has a simple structure, sufficing the design requirement of miniaturization and thinning-down. Furthermore, the rotating mechanism provides enough space for a bigger size display component or an input component to overcome the drawbacks of the prior arts, which can not proceed further miniaturization or have to select the smaller size display for miniaturization.

### BRIEF DESCRIPTION OF THE DRAWINGS

The foregoing aspects and many of the attendant advantages of this invention will become more readily appreciated as the same becomes better understood by reference to the following detailed description, when taken in conjunction with the accompanying drawings, wherein:

FIG. 1 is a perspective view showing a hand-held input device in accordance with a first embodiment of the present invention with rotating angle of a rotating component with respect to a shell body being zero degree;

FIG. 2 is similar to FIG. 1 but showing the rotating angle of rotating component with respect to the shell body is 90 degrees;

FIG. 3 shows an exploded view of the hand-held input device according to the first embodiment of the present invention;

FIG. 4 is a front view, illustrating the rotating component rotates 90 degrees with respect to the shell body;

FIG. 5 is similar to FIG. 4 but illustrating the rotating component rotating zero degrees with respect to the shell body;

FIG. 6 shows a cross-sectional view of the hand-held input device according to first embodiment of the present invention;

FIG. 7 is another perspective of the hand-held input device according to the first embodiment of the present invention;

FIG. 8 is a front view showing a one-body type hand-held input device according to the present invention;

FIG. 9 is a perspective view of a hand-held input device according to a second embodiment of the present invention;

FIG. 10 is an exploded view of the hand-held input device according to the second embodiment of the present invention;

FIG. 11 is another exploded view of the hand-held input device according to the second embodiment of the present invention;

FIG. 12 is an enlarged view of a portion of the hand-held input device according to the second embodiment of the present invention; and

FIG. 13 is a cross-sectional view of a portion of the hand-held input device according to the second embodiment of the present invention.

### DETAILED DESCRIPTION OF THE PREFERRED EMBODIMENTS

The foregoing aspects and many of the attendant advantages of this invention will become more readily appreciated as the same becomes better understood by reference to the following detailed description, when taken in conjunction with the accompanying drawings. Significantly, the present invention also can be applied for a revolvable input component of a hand-held input device.

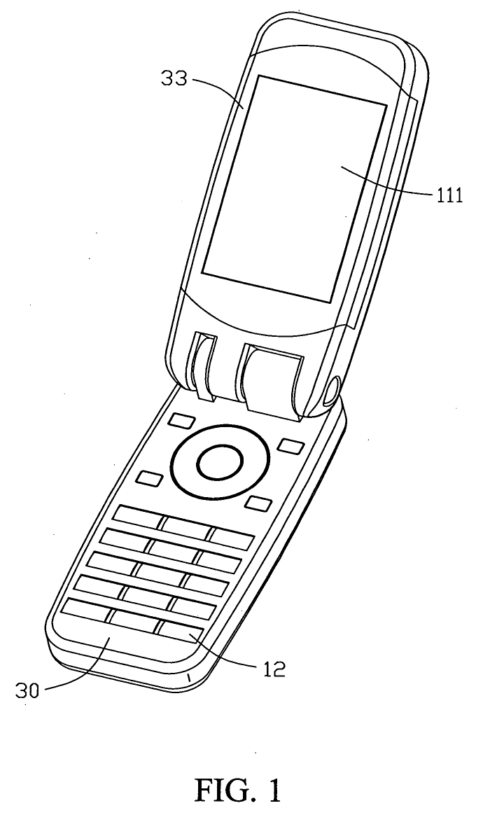

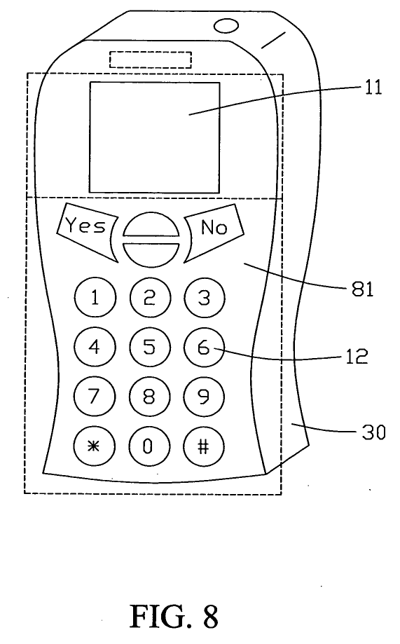

Please refer to FIG. 1 and FIG. 8, which illustrate a shell body 30, the shell body 30 comprises a display component 11 and an input component 12. The two components are assembled by a pivot (folding type, as shown in FIG. 1) or united all in one (one-body type, as shown in FIG. 8). However, the type will not be the restriction on the application of the present invention. FIG. 1 shows a front view that a rotating component 33 is closed to the shell body 30 when the rotating angle of the rotating component 33 with respect to the shell body 30 is zero degree.

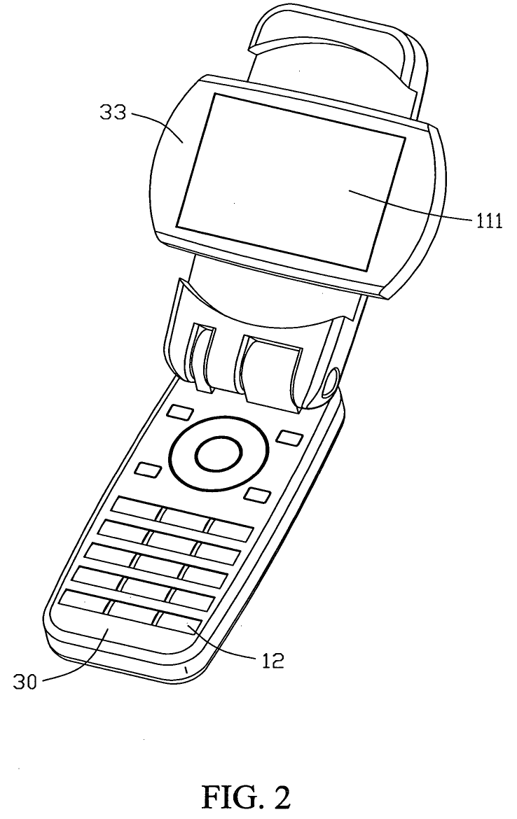

Please refer to FIG. 2, which shows a front view that the rotating component 33 is perpendicular to the shell body 30 when the rotating angle of the rotating component 33 with respect to the shell body 30 is 90 degrees.

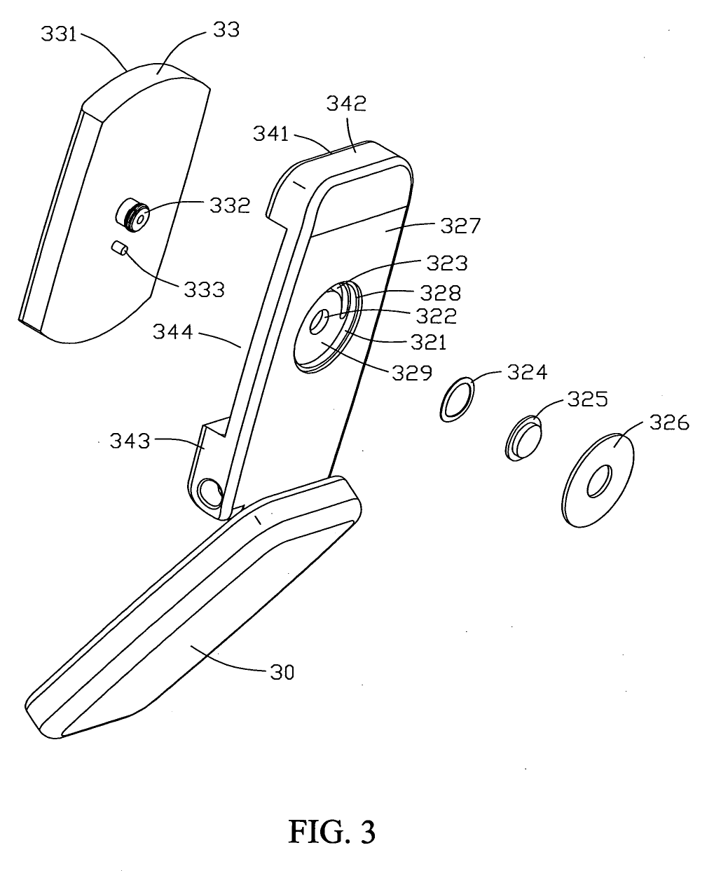

Please refer to FIG. 3, which illustrates a hand-held input device having a rotating mechanism according to the present invention, the shell body 30 comprises a display component 11 and an input component 12. The display component 11 and the input component 12 are assembled together by a pivot. The shell body 30 comprises an inner surface 341 to which the rotating component 33 is mounted and an outer surface 327 opposite to the inner surface 341. The outer surface 327 of the shell body 30 comprises a storage cavity 321 where a spindle hole 322 is formed. A quarter circle shaped guide groove 323 is further formed between the spindle hole 322 and a cavity wall 328. Moreover, the rotating component 33 comprises a display side 331 (or an input side 81 shown in FIG. 8), and an opposite side on which a spindle 332 and a guider 333 are assembled. The spindle 332 further comprises threads (not labeled). The spindle 332 and the guider 333 are received in the spindle hole 332 and the guide groove 323 of the shell body 30, respectively. The spindle 332 extends from the inner surface 341 through the spindle hole 322 and threadingly engages a pressing ring 325. An elastic part 324 is arranged around a portion of the pressing ring 325, and located between a cavity bottom 329 and a flange 62 of the pressing ring 325. The elastic part 324 keeps a space between the rotating component 33 and the shell body 30. Furthermore, the storage cavity 321 is capped with a cover 326. The spindle 332, the spindle hole 322, the elastic part 324, the pressing ring 325 and the cover 326 are arranged in a concentric manner about the same axis. The rotation component 33 can rotate within a specified rotating angle range with respect to the shell body 30 by the guider 333 moving in the guide groove 323. Therefore, the display side 331 (the input side 81) can be rotated (adjusted) a proper angle for watching and inputting.

A first arc concave 342 is formed at one side of the inner surface 341 and a second arc concave 343 is formed at the other side so that the inner surface 341, the first concave 342 and second concave 343 forms a holding compartment 344 for the rotating component 33.

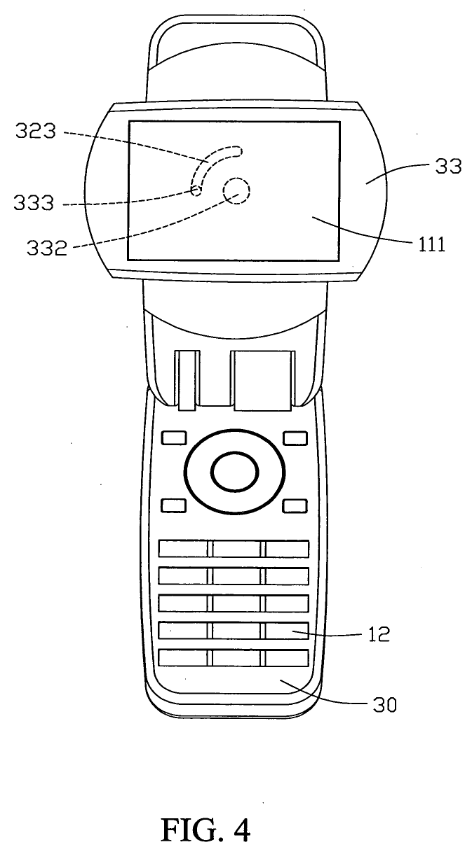

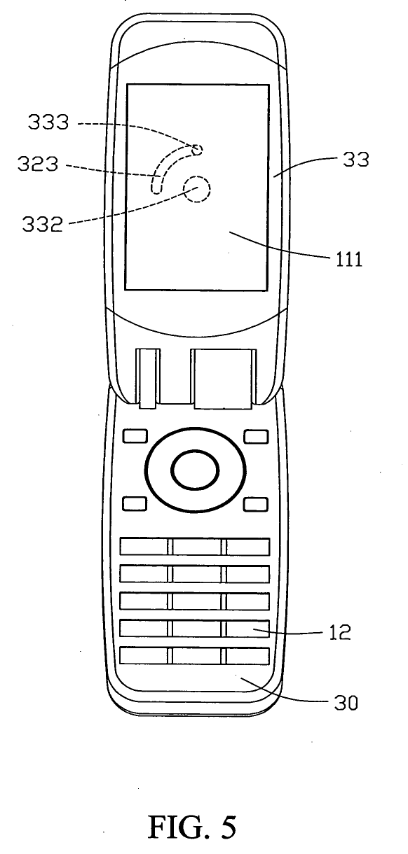

Referring to FIGS. 4 and 5, which illustrate the rotating component 33 rotating 90 degrees with respect to the shell body 30, zero degrees with respect to the shell body 30, respectively, the movement of the guider 333 in the guide groove 323 during the rotation of the rotating component 33 can become better understood from the FIG. 4 and FIG. 5.

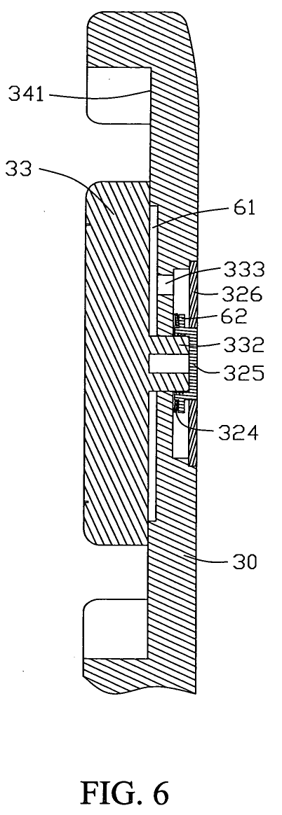

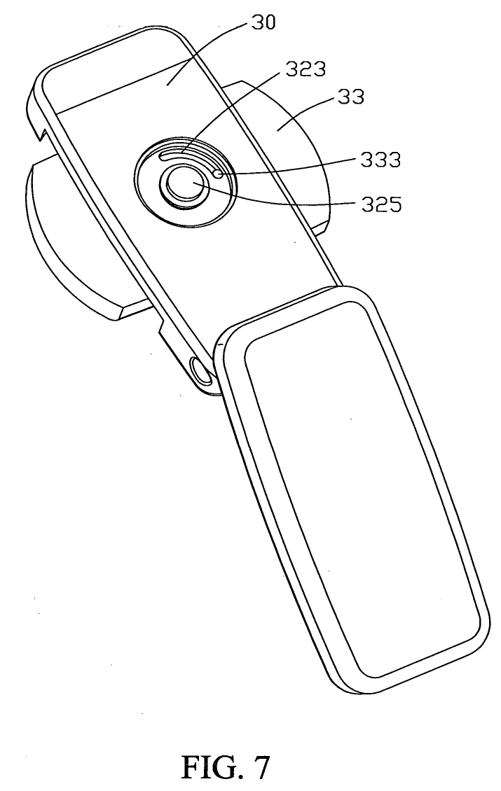

Referring to FIGS. 6 and 7, the inner surface 341 contacting the rotating component 33 further comprises a gap 61 between the rotating component 33 and the shell body 30 to reduce the contacting area (friction) inbetween so that the rotating component 33 can rotate more smoothly. Moreover, the shape of the spindle 332 is a hollow column for easy injection molding and the plastic material of the spindle 332 cools down uniformly to prevent the drawbacks of the injection mold's crooking or bending. Furthermore, the internal diameter of the pressing ring 325 is larger than the external diameter of the spindle 332. The flange 62 set around the pressing ring 325 can fix the elastic part 324 to the shell body 30.

The aforementioned rotating component 33 can be a display or an input device. The display may be a STN, TFT, OLED or et cetera. The input device may be a keyboard, touch panel or et cetera. The elastic part 324 can be a wavy spring or other elastic element. Obviously, in the hand-held input device provided by the present invention, the guide groove 323 formed in the storage cavity 321 of the shell body 30 and the guider 333 assembled to the backside of the rotating component 33 are essentially a rotation limitation mechanism providing a rotating angle range limitation to the rotating component 33. The rotation limitation mechanism rotates the rotating component 33 within a specified rotating angle range with respect to the shell body 30. However, the rotation limitation mechanism is not specified to the assembled guide groove 323 and guider 333 mentioned above. Any structure idea of providing limitation basing on the concept of the present invention is included within the spirit and scope of the rotation limitation mechanism according to the present invention.

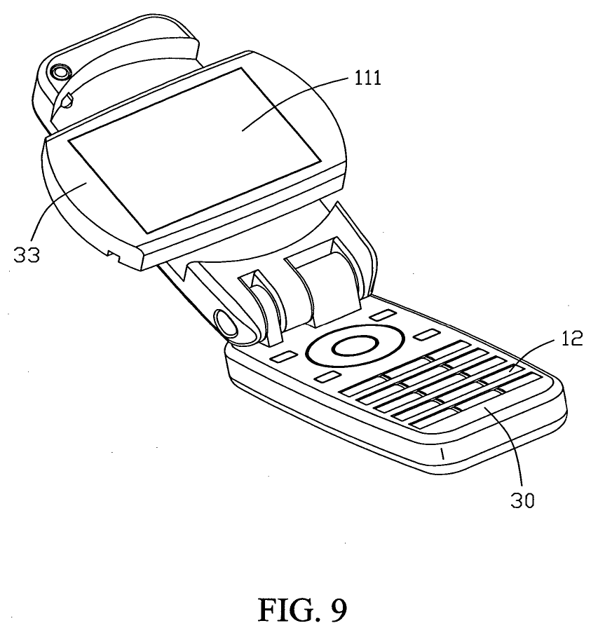

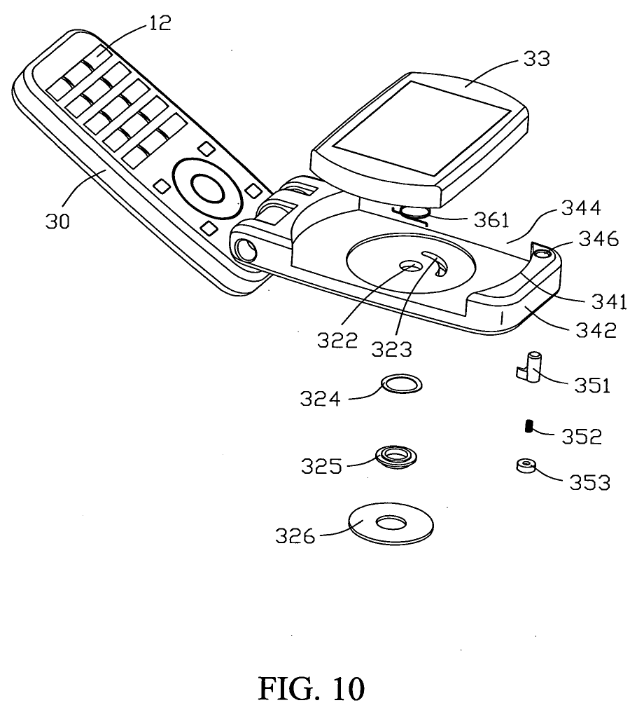

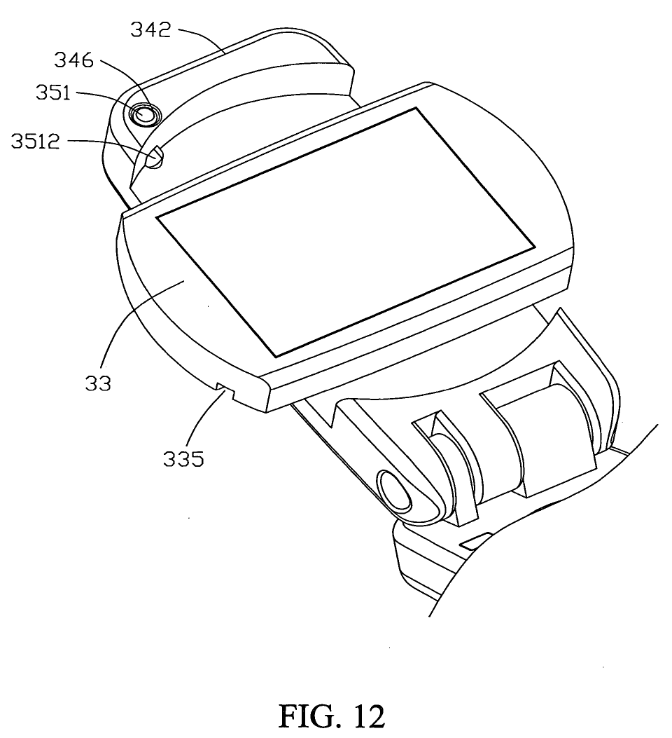

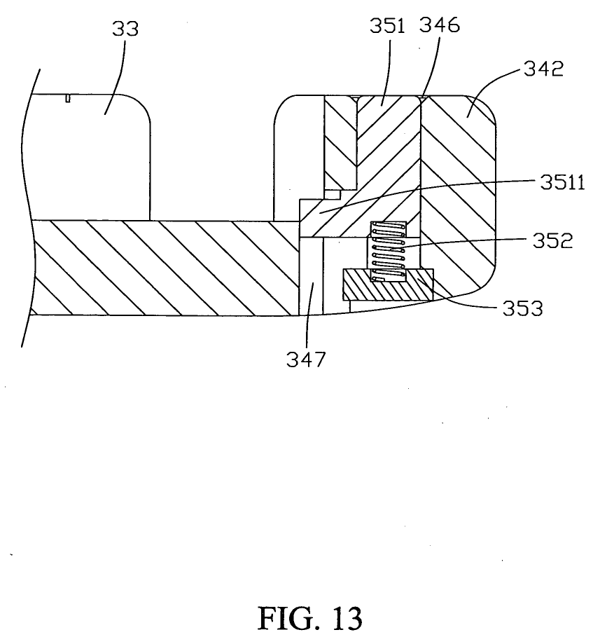

FIGS. 9 to 13 show a hand-held input device according to a second embodiment of the present invention. The second embodiment is constructed on the foundation of first embodiment. With a torsional spring 361 and a detent mechanism to provide an automatic rotation function. As shown in FIG. 10, a torsional spring 361 is arranged between the shell body 30 and the bottom of the holding compartment 344. The torsional spring 361 can be attached to the spindle 332 that one end of the torsional spring 361 is fixed on the inner surface 341 in the holding compartment 344 of the shell body 30, and the opposite end is fixed to the backside of the rotating component 33 to rotate the rotating component 33 a specified angle automatically if no resistance is applied on the rotating component 33. Furthermore, the shell body 30 further comprises a button hole 346 through the first concave 342. The button hole 346 is extended in the outer surface 327 of the shell body 30 to form a detent hole 347, which extends to the inner surface 341 of the shell body 30 and in communication with the holding compartment 344. A column-shaped detent button 351 is received in the button hole 346. A bottom end of the detent button 351 comprises a detent arm 3511 having a tilting surface 3512 (as shown in FIG. 12). The detent button 351 is inserted into the button hole 346 from the outer surface 327 side of the shell body 30. The detent arm 3511 at the bottom end fits for the detent hole 347 to extend into the holding compartment 344 of the shell body 30 and the top end stretches out the surface of the first concave 342 for access by the user. Furthermore, after the detent button 351 is inserted into the button hole 346, the bottom end of the detent button 351 is attached with a spring 352 and a fixer 353, wherein the fixer 353 is fixed in the button hole 346 at the outer surface 327 and the spring 352 is attached between the detent button 351 and the fixer 353 to bias the detent arm 3511 into the holding compartment 344 of the shell body 30 in a normal condition with the elasticity of the spring 352.

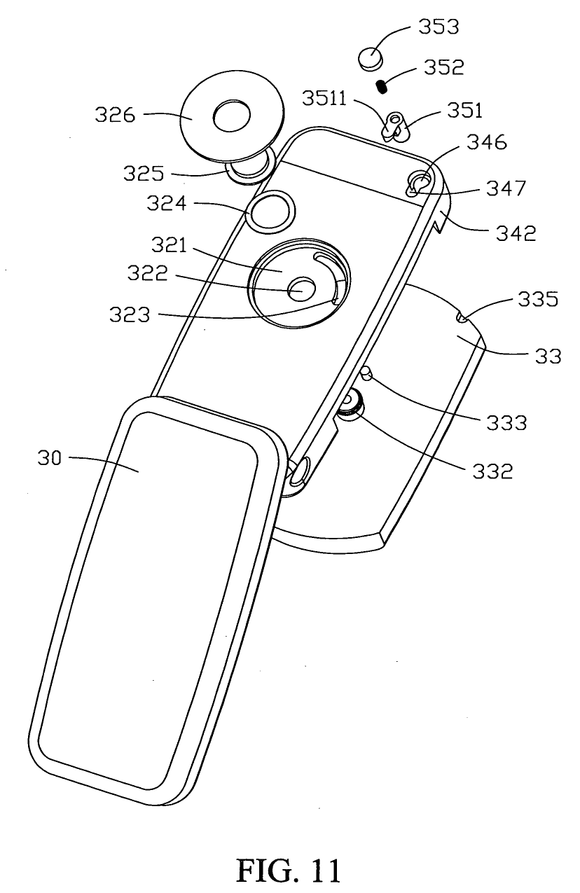

As shown in FIGS. 11 and 12, a mortise 335 is formed in the back side of the rotating component 33 corresponding to the detent arm 3511 of the detent button 351 to locate the rotating component 33 by engaging the detent arm 3511 with the mortise 335. Securing the rotating component 33 from rotation with respect to the shell body 30 can be achieved. When a user pushes the detent button 351, the detent arm 3511 is drew back into the detent hole 347 and unlocks the rotating component 33 to drive the rotating component 33 not rotating with the strain of the torsional spring 361 until the guider 333 is stopped at the end of the guide groove 323. The user can manually rotate the rotating component 33 if the user wants to get the rotating component 33 back to the original position. When the rotating component 33 is rotated back to touch the detent arm 3511, the rotating component 33 touches and presses the tilting surface 3512 to move downwards and withdrew from the holding compartment 344 due to the tilting surface 3512 of the detent arm 3511 until the mortise 335 comes at the corresponding position to the detent arm 3511. At present, the detent arm 3511 is extended into the holding compartment 344 to engage with the mortise 335 with the elastic force of the spring 352 for securing the rotating component 33. When the detent button 351 is pushed again, the rotating component 33 rotates again with the strain of the torsional spring 361 again.

Obviously, for preventing the rotating component 33 hits the end of the guide groove 323 and cracks due to a wild automatic rotation overdrove by the torsional spring 361, a buffer member, e.g. soft spring or other elastic element can be assembled in or beside the guide groove 323 to slow the guider 333 of the rotating component 33 by interfering with the movement of the guider 333 and safely drives the guider 333 arrived at the end of the guide groove 323.

As is understood by a person skilled in the art, the foregoing preferred embodiments of the present invention are illustrative rather than limiting of the present invention. It is intended that they cover various modifications and similar arrangements be included within the spirit and scope of the appended claims, the scope of which should be accorded the broadest interpretation so as to encompass all such modifications and similar structure.

What is claimed is:

1. A hand-held input device comprising:
a shell body defining a spindle hole;
a rotating component, comprising a spindle rotatably received in the spindle hole of the shell body to rotatably connect the rotating component to the shell body;
a rotation limitation mechanism, assembled at one of the shell body and the rotating component or both, limiting the rotation of the rotating component within a specified rotating angle range with respect to the shell body.

2. The hand-held input device according to claim 1, wherein the rotation limitation mechanism comprises a guide groove defined in the shell body and a guider formed on the rotating component and movably received in the guide groove.

3. The hand-held input device according to claim 1, wherein the spindle of the rotating component is mounted to the shell body by threading engagement with a pressing ring.

4. The hand-held input device according to claim 3, wherein the pressing ring has a flange.

5. The hand-held input device according to one of claim 3, wherein the spindle of the rotating component is further attached with a torsional spring having one end fixed to the shell body and an opposite end fixed to the rotating component to drive the rotating component rotating automatically if no resistance is applied on the rotating component.

6. The hand-held input device according to claim 1, further comprising an elastic part between the spindle and the pressing ring to keep a space between the shell body and the rotating component.

7. The hand-held input device according to claim 6, wherein the elastic part comprises a wavy spring.

8. The hand-held input device according to claim 6, wherein the spindle of the rotating component is further attached with a torsional spring having one end fixed to the shell body an opposite end fixed to the rotating component to drive the rotating component rotating automatically if no resistance is applied on the rotating component.

9. The hand-held input device according to claim 1, wherein the shell body comprises an input component and a display component, the spindle hole and the guide groove being formed in one of the display component and the input component.

10. The hand-held input device according to one of claim 9, wherein the spindle of the rotating component is further attached with a torsional spring having one end fixed to the shell body and an opposite end fixed to the rotating component to drive the rotating component rotating automatically if no resistance is applied on the rotating component.

11. The hand-held input device according to claim 1, wherein the shell body comprises a storage cavity having a bottom in which the spindle hole and the guide groove are formed.

12. The hand-held input device according to claim 13, wherein the storage cavity is capped with a cover.

13. The hand-held input device according to claim 1, wherein the spindle further comprises threads for threadingly engaging the pressing ring.

14. The hand-held input device according to claim 1, wherein the rotating component comprises an input side and the spindle and the guider are assembled on the opposite side of the input side.

15. The hand-held input device according to claim 1, wherein the shell body further comprises a button hole, in which a detent button is received, and a mortise is set up on the rotating component corresponding to the detent button to secure the rotating component by engaging the detent button with the mortise.

16. The hand-held input device according to claim 20, wherein the detent button comprises a column, having a bottom end forming a detent arm having a tilting surface.

17. The hand-held input device according to claim 20, wherein the detent hole is extended in the outer surface side of the shell body to form a detent hole, which extends to the inner surface of the shell body and in communication with a holding compartment.

18. The hand-held input device according to one of claim 20, wherein a first arc concave is formed at one side of the inner surface and a second arc concave is formed at the other side so that the inner surface, the first concave and second concave form a holding compartment for the rotating component.

19. The hand-held input device according to one of claim 20, wherein the detent button is extended into the button hole from the outer surface side of the shell body, the detent arm at the bottom end of detent button fits the detent hole to extend into the holding compartment, the top end extends out the surface of the first concave.

20. The hand-held input device according to claim 24, wherein the bottom end of the detent button is attached with a spring and a fixer which is fixed in the button hole at the outer surface side and the spring is attached between the detent button and the fixer to bias the detent arm into the holding compartment for securing the rotating component by engaging the detent arm with the mortise in a normal condition.
